(19) United States
(12) Patent Application Publication
(10) Pub. No.: US 2021/0049689 A1
(43) Pub. Date: Feb. 18, 2021

(54) STOCK PRICE ESTIMATION METHOD AND APPARATUS

(71) Applicant: Bo PENG, Shenzhen (CN)

(72) Inventor: Bo PENG, Shenzhen (CN)

(21) Appl. No.: 16/581,785

(22) Filed: Sep. 25, 2019

(30) Foreign Application Priority Data
Aug. 15, 2019 (CN) 201910755560.0

(51) Int. Cl. G06Q 40/04; G06Q 40/06

(52) U.S. Cl. CPC G06Q 40/04; G06Q 40/06

(57) ABSTRACT

A stock price estimation method, apparatus, and device. The method comprises: obtaining current tick data of a stock, wherein the current tick data comprises N best prices and corresponding buy/sell volumes of the stock, where N is a positive integer greater than 1; determining, by using money to be invested or money to be withdrawn and the current tick data, a final transaction price if all the money to be invested is used to buy the stock or all the money to be withdrawn is obtained by selling the stock; and presenting the final transaction price in real time for an investor's reference. By means of the stock price estimation method provided in the embodiments of the present invention, the fluctuation of a final price of a stock under the impact of a particular amount of money can be calculated by using current tick information.

### Cross Reference to the Related Applications

This application is based upon and claims priority to Chinese Patent Application No. 201910755560. 0, filed on Aug. 15, 2019, the entire contents of which are incorporated herein by reference.

### TECHNICAL FIELD

The embodiments of the present invention relate to the field of computer-based financial technology, and more specifically, to a stock price estimation method and apparatus.

### BACKGROUND

In an existing stock transaction matching system, all orders of a stock are collected in an entire market, orders are matched and traded according to a particular rule based on lot sizes and prices of the orders during opening hours to form a real-time stock price.

Stock prices change constantly. An exchange settles transactions per unit of time, announces results in real time, and refreshes a latest price. Stock prices are also restricted by price limits in China. To be specific, daily price limits are 10%. The remaining orders on a current day cannot be traded once the price limits are reached.

During actual trading, each order is actually traded only when there is a counterparty order that satisfies a condition. During actual trading, each order is actually traded only when there is a counterparty order that satisfies a condition. For example, a sell order for 100 lots at 15 Yuan is placed. When someone places a buy order at a price higher than 15 Yuan, the lots of the buy order are traded at 15 Yuan. The remaining lots remain in an exchange system and wait for subsequent matching and trading.

In this way, when a particularly large amount of money is used to buy the stock or the stock is to be sold for a particularly large amount of money, orders need to be traded one by one and are traded at different prices. There will also be a hammering or holding effect, and it becomes more difficult to grab chips. Moreover, restricted by price limits in China, all orders cannot be traded within one day. For various reasons, it is usually impossible to predict the overall buying or selling costs and is also impossible to predict a stock price after the orders are traded. No corresponding estimation methods are commercially available at present.

Therefore, how to provide a stock price estimation solution that can provide reference for large amounts of financial investment is an urgent problem that needs to be resolved by a person skilled in the art.

### SUMMARY

In view of this, the embodiments of the present invention provide a stock price estimation method, apparatus, and device, to provide reference for financial investment.

In order to achieve the above object, the embodiments of the present invention provide the following technical solutions:

According to a first aspect, an embodiment of the present invention provides a stock price estimation method, comprising:

obtaining current tick data of a stock, wherein the current tick data comprises N best prices and corresponding buy/sell volumes of the stock, where N is a positive integer greater than 1;

determining, by using money to be invested or money to be withdrawn and the current tick data, a final transaction price if all the money to be invested is used to buy the stock or all the money to be withdrawn is obtained by selling the stock; and

presenting the final transaction price in real time for an investor's reference.

Preferably, the current tick data comprises: an N^{th} best seller price sequentially arranged in ascending order of price and an N^{th} best seller stock volume; and

the determining, by using money to be invested or money to be withdrawn and the current tick data, a final transaction price if all the money to be invested is used to buy the stock or all the money to be withdrawn is obtained by selling the stock comprises:

receiving an amount of the money to be invested;

sequentially buying the stock at the N^{th} best seller price in ascending order of seller price by using the money to be invested; and

if the money to be invested is used up, taking a price at which the stock is bought when the money to be invested is used up as the final transaction price.

Preferably, the method further comprises:

if the money to be invested is not used up, calculating a first proportional relationship between a money usage of the money to be invested and the money to be invested; and

determining the final transaction price by making a second proportional relationship between a first difference and a second difference equal the first proportional relationship, wherein the second difference is a difference between the final transaction price and a current market price, and the first difference is a difference between the N^{th} best seller price and the current market price.

Preferably, the current tick data comprises: an N^{th} best buyer price sequentially arranged in descending order of price and an N^{th} best buyer stock volume; and

the determining, by using money to be invested or money to be withdrawn and the current tick data, a final transaction price if all the money to be invested is used to buy the stock or all the money to be withdrawn is obtained by selling the stock comprises:

receiving an amount of the money to be withdrawn;

sequentially trading the stock at the N^{th} best buyer price in descending order of buyer price; and

if the amount of the money to be withdrawn is reached through accumulation, taking a price at which the stock is traded when the money to be invested is reached as the final transaction price.

Preferably, if the amount of the money to be withdrawn is not reached, a third proportional relationship between an accumulated amount of money that has been withdrawn currently and the money to be withdrawn is calculated; and

the final transaction price is determined by making a fourth proportional relationship between a third difference and a fourth difference equal the third proportional relationship, wherein the third difference is a difference between the current market price and the N^{th} best buyer price, and the fourth difference is a difference between the current market price and the final transaction price.

Preferably, the determining, by using money to be invested or money to be withdrawn and the current tick data, a final transaction price if all the money to be invested is used to buy the stock or all the money to be withdrawn is obtained by selling the stock comprises:

calculating, by using the current tick data, a full amount of money for trading all stocks in a current tick;

calculating a fifth proportional relationship between the money to be invested or the money to be withdrawn and the full amount of money; calculating a sixth comparison relationship between a fifth difference and a sixth difference, wherein the fifth difference is a difference between the final transaction price and the current market price, and the sixth difference is a seller price maximum difference or a buyer price maximum difference in the current tick data; and

determining the final transaction price by making the fifth proportional relationship equal the sixth proportional relationship.

According to a second aspect, an embodiment of the present invention provides a stock price estimation apparatus, comprising:

a module for obtaining current tick data, configured to obtain current tick data of a stock, wherein the current tick data comprises N best prices and corresponding buy/sell volumes of the stock, where N is a positive integer greater than 1;

a module for determining a final transaction price, configured to determine, by using money to be invested or money to be withdrawn and the current tick data, a final transaction price if all the money to be invested is used to buy the stock or all the money to be withdrawn is obtained by selling the stock; and

a real-time price presentation module, configured to present the final transaction price in real time for an investor's reference.

Preferably, the module for determining a final transaction price comprises:

a unit for calculating a full amount of money, configured to calculate, by using the current tick data, a full amount of money for trading all stocks in a current tick;

a difference proportion determination unit, configured to: calculate a fifth proportional relationship between the money to be invested or the money to be withdrawn and the full amount of money; and calculate a sixth comparison relationship between a fifth difference and a sixth difference, wherein the fifth difference is a difference between the final transaction price and the current market price, and the sixth difference is a seller price maximum difference or a buyer price maximum difference in the current tick data; and

a final price determination unit, configured to determine the final transaction price by making the fifth proportional relationship equal the sixth proportional relationship.

According to a third aspect, an embodiment of the present invention provides a stock price estimation device, comprising:

a memory, configured to store a computer program; and

a processor, configured to implement, when executing the computer program, the steps of any foregoing stock price estimation method in the first aspect.

According to a fourth aspect, an embodiment of the present invention provides a computer-readable storage medium, wherein the computer-readable storage medium stores a computer program, and the computer program implements, when being executed by the processor, the steps of any foregoing stock price estimation method in the first aspect.

The embodiments of the present invention provide the stock price estimation method, comprising: obtaining current tick data of a stock, wherein the current tick data comprises N best prices and corresponding buy/sell volumes of the stock, where N is a positive integer greater than 1; determining, by using money to be invested or money to be withdrawn and the current tick data, a final transaction price if all the money to be invested is used to buy the stock or all the money to be withdrawn is obtained by selling the stock; and presenting the final transaction price in real time for an investor's reference. By means of the stock price estimation method provided in the embodiments of the present invention, the fluctuation of a final price of a stock under the impact of a particular amount of money can be calculated by using current tick information, so that useful reference can be provided for investors to make stock financial investment.

The stock price estimation method, apparatus, device provided in the embodiments of the present invention have the same beneficial effects. Details are not described herein one by one again.

### BRIEF DESCRIPTION OF THE DRAWINGS

To describe the technical solutions in the implementations of the present invention or in the prior art more clearly, the following briefly introduces the accompanying drawings required for describing the implementations or the prior art. Apparently, the accompanying drawings in the following description show some embodiments of the present invention, and persons of ordinary skill in the art may still derive other drawings from these accompanying drawings without creative efforts.

The structures, proportions, sizes and the like depicted in this specification are only used to fit with the content disclosed in the specification for understanding and reading by those skilled in the art, but are not intended to limit the limitation conditions that can be implemented in the present invention, and thus have no technically substantive meaning Any of the modification of structure, the change of proportional relationship or the adjustment of size should fall within the scope covered by the technical content disclosed in the present invention without affecting the effects produced and the object achievable by the present invention.

FIG. 1 is a flowchart of a stock price estimation method according to an embodiment of the present invention;

FIG. 2 is a flowchart of a stock price estimation method according to an embodiment of the present invention;

FIG. 3 is still another flowchart of a stock price estimation method according to an embodiment of the present invention;

FIG. 4 is still another flowchart of a stock price estimation method according to an embodiment of the present invention;

FIG. 5 is another flowchart of a stock price estimation method according to an embodiment of the present invention;

FIG. 6 is another flowchart of a stock price estimation method according to an embodiment of the present invention;

FIG. 7 is a schematic structural composition diagram of a stock price estimation apparatus according to an embodiment of the present invention;

FIG. 8 is a schematic structural composition diagram of a module for determining a final transaction price of a stock price estimation apparatus according to an embodiment of the present invention; and

FIG. 9 is a schematic structural diagram of a stock price estimation device according to a specific implementation of the present invention.

### DETAILED DESCRIPTION

The embodiments of the present invention are illustrated below by using the specific embodiments, and those skilled in the art would have readily understood other advantages and effects of the present invention from the disclosure of this specification, and it is obvious that the described embodiments are some of the embodiments of the present invention rather than all the embodiments. Based on the embodiments of the present invention, all other embodiments obtained by those of ordinary skill in the art without involving any inventive effort fall within the scope of protection of the present invention.

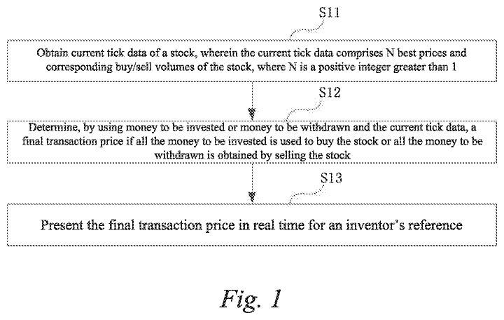

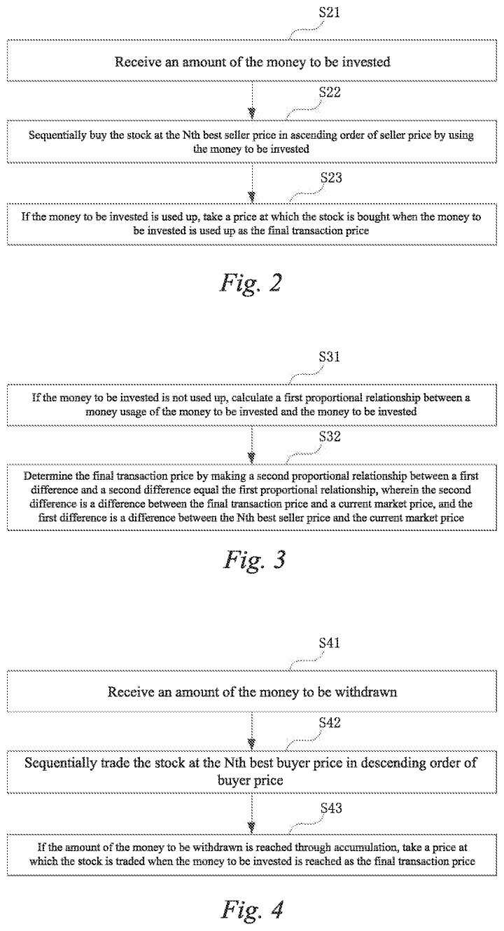

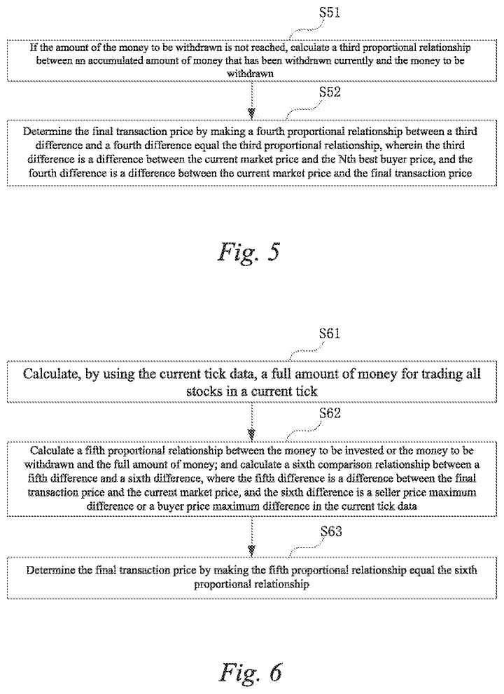

Refer to FIG. 1, FIG. 2, FIG. 3, FIG. 4, FIG. 5, and FIG. 6. FIG. 1 is a flowchart of a stock price estimation method according to an embodiment of the present invention. FIG. 2 is a flowchart of a stock price estimation method according to an embodiment of the present invention. FIG. 3 is still another flowchart of a stock price estimation method according to an embodiment of the present invention. FIG. 4 is still another flowchart of a stock price estimation method according to an embodiment of the present invention. FIG. 5 is another flowchart of a stock price estimation method according to an embodiment of the present invention. FIG. 6 is another flowchart of a stock price estimation method according to an embodiment of the present invention.

In a specific implementation of the present invention, an embodiment of the present invention provides a stock price estimation method, comprising:

Step S11: obtaining current tick data of a stock, wherein the current tick data comprises N best prices and corresponding buy/sell volumes of the stock, where N is a positive integer greater than 1;

Step S12: determining, by using money to be invested or money to be withdrawn and the current tick data, a final transaction price if all the money to be invested is used to buy the stock or all the money to be withdrawn is obtained by selling the stock; and

Step S13: presenting the final transaction price in real time for an investor's reference.

In this embodiment of the present invention, current tick data of a stock that an investor intends to trade needs to be obtained first. Generally, a stock has fixed trading time. For example, for Chinese stocks listed in Shanghai Stock Exchange or Shenzhen Stock Exchange, the normal trading time is 9:30 to 11:30 and 13:00 to 15:00 from Monday to Friday. During stock trading, trading information of five best buy/sell orders of an individual stock is specifically used. “Tick” means using tape reading to observe the trend of trading in a stock market. Certainly, there are ticks with other best orders, for example, tick data of 10 best orders. Seller and buyer order prices and corresponding stock volumes, namely, tick data, of a stock to be traded may be first obtained.

After tick data is obtained, money to be invested or money to be withdrawn and the current tick data may be used to determine the final transaction price. Because the amount of the money to be invested or the money to be withdrawn may reach none of the amounts of the buy orders or sell orders in a current tick, in this case, a precise final transaction price may be obtained. For example, when the money to be invested is used to buy a stock, the current tick data comprises: an N^{th} best seller price sequentially arranged in ascending order of price and an N^{th} best seller stock volume. Specifically, if the tick data is five best seller prices, the prices are sequentially a first best seller price, a second best seller price, a third best seller price, a fourth best seller price, and a fifth best seller price in ascending order. The determining, by using money to be invested or money to be withdrawn and the current tick data, a final transaction price if all the money to be invested is used to buy the stock or all the money to be withdrawn is obtained by selling the stock may specifically include the following steps:

Step S21: Receive an amount of the money to be invested.

Step S22: Sequentially buy the stock at the N^{th} best seller price in ascending order of seller price by using the money to be invested; and

Step S23: If the money to be invested is used up, take a price at which the stock is bought when the money to be invested is used up as the final transaction price.

First, an amount of money that an investor can use to buy the stock needs to be received. Subsequently, the amount of money is used for estimation. Certainly, a fixed amount of money to be invested or money to be withdrawn may be set. For example, a value of 10 million, 20 million or the like may be set. If the stock at the N^{th} best seller price is sequentially bought in ascending order of seller price and the money is already used up before the stock in the current tick is sold out, the stock price when the money is used up is the final transaction price. Specifically:

In an example, tick data (five best orders or ten best orders) may be introduced, and five best orders are used as an example. A particular amount, for example, 30 million, of virtual money is preset. Certainly, the investor may enter another amount of virtual money.

During buying, data of ask 1 to ask 5 is used. The number of lots of each best order is multiplied by a corresponding price. It should be noted that the ask price 1 to the ask price 5 are in ascending order. Each lot is equal to 100 shares. Therefore, the product is further multiplied by 100:

ask size 1*ask price 1*100=ask sum 1;

ask size 2*ask price 2 *100=ask sum 2;

ask size 3*ask price 3 *100=ask sum 3;

ask size 4*ask price 4 *100=ask sum 4; and

ask size 5*ask price 5*100=ask sum 5.

The ask sum 1 to the ask sum 5 are added. During the addition, as soon as the sum exceeds 30 million, the price corresponding to the last sum is the final estimated price.

For example, ask sum 1+ask sum 2=26 million, and ask sum 1+ask sum 2+ask sum 3=31 million. In this case, the ask price 3 is the final estimated price.

Certainly, during specific implementation, the amount of the money to be invested may be relatively large. In this case, the money to be invested may still be not used up after all the stocks in the current tick have been bought. In this case, the following steps may be performed to estimate the final transaction price:

Step S31: If the money to be invested is not used up, calculate a first proportional relationship between a money usage of the money to be invested and the money to be invested.

Step S32: Determine the final transaction price by making a second proportional relationship between a first difference and a second difference equal the first proportional relationship, wherein the second difference is a difference between the final transaction price and a current market price, and the first difference is a difference between the N^{th} best seller price and the current market price.

The current market price is the first best buyer price or the first best seller price. Certainly, the current market price may be another price. Because the current market price is the stock price of the latest transaction at present, the current market price may be the first best buyer price or the first best seller price or may be another price. Specifically, the current market price may be obtained from tick information.

Specifically, if the sum of the ask sum 1 to the ask sum 5 still does not reach 30 million, the following estimation is performed:

ask sum 1+ask sum 2+ask sum 3+ask sum 4+ask sum 5=tick sum;

ask price 5−ask price 1=tick difference;

30 million/tick sum=quotient;

tick difference*quotient=price increment; and

final estimated price=current price(current stock price)+price increment.

That is, the tick money is the money usage, and a proportional relationship between a rise/drop proportion of the price and the money usage is used to estimate the final transaction price. Certainly, in practice, this is not the case. Generally, the more shares are bought, the unit increment of price costs more money. However, the proportional relationship thereof is approximate to a linear relationship. During specific implementation, the use of a linear relationship is of practical significance.

In still another embodiment of the present invention, if an investor owns a large number of shares and currently needs cash, the investor needs to sell the stock. In this case, the price of the stock after a required amount of cash is withdrawn needs to be estimated. Specifically, the current tick data comprises: an N^{th} best buyer price sequentially arranged in descending order of price and an N^{th} best buyer stock volume; and the determining, by using money to be invested or money to be withdrawn and the current tick data, a final transaction price if all the money to be invested is used to buy the stock or all the money to be withdrawn is obtained by selling the stock comprises:

Step S41: Receive an amount of the money to be withdrawn.

Step S42: Sequentially trade the stock at the N^{th} best buyer price in descending order of buyer price; and

Step S43: If the amount of the money to be withdrawn is reached through accumulation, take a price at which the stock is traded when the money to be invested is reached as the final transaction price.

Specifically, during selling, data of bid 1 to bid 5 is used. The number of lots of each best order is multiplied by a corresponding price. The bid price 1 to the bid price 5 are in descending order (hence the worst price). Similarly, each lot is equal to 100 shares. The product is multiplied by 100:

bid size 1*bid price 1*100=bid sum 1;

bid size 2*bid price 2*100=bid sum 2;

bid size 3*bid price 3*100=bid sum 3;

bid size 4*bid price 4*100=bid sum 4; and

bid size 5*bid price 5*100=bid sum 5.

The bid sum 1 to the bid sum 5 are added. During the addition, as soon as the sum exceeds 30 million, the price corresponding to the last sum is the final estimated price.

For example, the bid sum 1+the bid sum 2=26 million, and the bid sum 1+the bid sum 2+the bid sum 3=31 million. In this case, the bid price 3 is the final estimated price, that is, the final transaction price.

However, during specific implementation, if the amount of money that needs to be withdrawn is relatively large, the amount of required money is not reached even if all the buyer orders in the current tick are traded. In this case, a proportional relationship between a sum and a stock price rise/drop may be used to estimate the final transaction price. Specifically, the following steps may be performed:

Step S51: If the amount of the money to be withdrawn is not reached, calculate a third proportional relationship between an accumulated amount of money that has been withdrawn currently and the money to be withdrawn.

Step S52: Determine the final transaction price by making a fourth proportional relationship between a third difference and a fourth difference equal the third proportional relationship, wherein the third difference is a difference between the current market price and the N^{th} best buyer price, and the fourth difference is a difference between the current market price and the final transaction price.

Specifically, in an example, if the sum of the bid sum 1 to the bid sum 5 still does not reach 30 million, the following estimation is performed:

bid sum 1+bid sum 2+bid sum 3+bid sum 4+bid sum 5=tick sum;

bid price 1−bid price 5=tick difference;

30 million/tick sum=quotient;

tick difference*quotient=price decrement; and

final estimated price=current price(current stock price)−price decrement.

The final estimated price is the final transaction price.

Certainly, the impact on a price in a stock market when money to be withdrawn is withdrawn from the stock market or the impact on the stock market when money to be invested is invested in a stock market are described in the foregoing embodiments. In practice, the relationships between the money to be invested or the money to be withdrawn and buy orders in a tick and an amount of money required in the buy orders are directly ignored. Instead, only proportional relationships are used to calculate the final transaction price. Specifically, the determining, by using money to be invested or money to be withdrawn and the current tick data, a final transaction price if all the money to be invested is used to buy the stock or all the money to be withdrawn is obtained by selling the stock may be specifically implemented by using the following steps:

Step S61: Calculate, by using the current tick data, a full amount of money for trading all stocks in a current tick.

Step S62: Calculate a fifth proportional relationship between the money to be invested or the money to be withdrawn and the full amount of money; calculate a sixth comparison relationship between a fifth difference and a sixth difference, wherein the fifth difference is a difference between the final transaction price and the current market price, and the sixth difference is a seller price maximum difference or a buyer price maximum difference in the current tick data.

Step S63: Determine the final transaction price by making the fifth proportional relationship equal the sixth proportional relationship.

Specifically, during implementation, regardless of whether an amount of money in a tick exceeds a preset amount of money or not, subsequent operations are performed: For example, bid sum 1+bid sum 2+bid sum 3=31 million. In this case, subsequent operation continues to be performed: 31 million+bid sum 4+bid sum 5=56 million; and 30 million/56 million=quotient; tick difference*quotient=price decrement; and final estimated price=current price−price decrement.

The embodiments of the present invention provide a stock price estimation method, by means of which the fluctuation of a final price of a stock under the impact of a particular amount of money can be calculated by using current tick information, so that useful reference can be provided for investors to make stock financial investment.

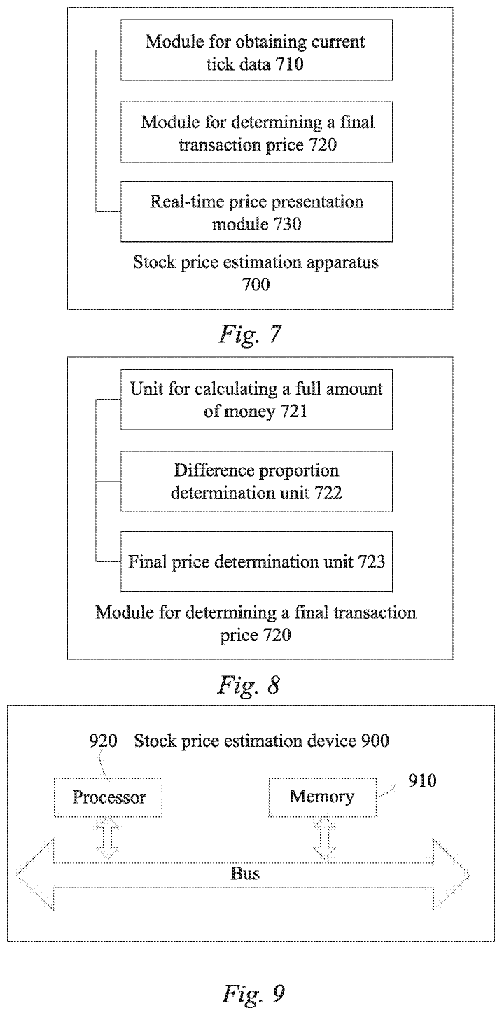

Refer to FIG. 7 and FIG. 8. FIG. 7 is a schematic structural composition diagram of a stock price estimation apparatus according to an embodiment of the present invention. FIG. 8 is a schematic structural composition diagram of a module for determining a final transaction price of a stock price estimation apparatus according to an embodiment of the present invention.

An embodiment of the present invention provides a stock price estimation apparatus 700, comprising:

a module 710 for obtaining current tick data, configured to obtain current tick data of a stock, wherein the current tick data comprises N best prices and corresponding buy/sell volumes of the stock, where N is a positive integer greater than 1;

a module 720 for determining a final transaction price, configured to determine, by using money to be invested or money to be withdrawn and the current tick data, a final transaction price if all the money to be invested is used to buy the stock or all the money to be withdrawn is obtained by selling the stock; and

a real-time price presentation module 730, configured to present the final transaction price in real time for an investor's reference.

Preferably, the module 720 for determining a final transaction price comprises:

a unit 721 for calculating a full amount of money, configured to calculate, by using the current tick data, a full amount of money for trading all stocks in a current tick;

a difference proportion determination unit 722, configured to: calculate a fifth proportional relationship between the money to be invested or the money to be withdrawn and the full amount of money; and calculate a sixth comparison relationship between a fifth difference and a sixth difference, wherein the fifth difference is a difference between the final transaction price and the current market price, and the sixth difference is a seller price maximum difference or a buyer price maximum difference in the current tick data; and

a final price determination unit 723, configured to determine the final transaction price by making the fifth proportional relationship equal the sixth proportional relationship.

Refer to FIG. 9. FIG. 9 is a schematic structural diagram of a stock price estimation device according to a specific implementation of the present invention.

An embodiment of the present invention provides a stock price estimation device 900, comprising:

a memory 910, configured to store a computer program; and

a processor 920, configured to implement, when executing the computer program, the steps in the stock price estimation method in any embodiment in the foregoing.

An embodiment of the present invention provides a computer-readable storage medium, wherein the computer-readable storage medium stores a computer program, and the computer program implements, when being executed by the processor, the steps in the stock price estimation method in any embodiment in the foregoing.

A person skilled in the art should understand that the embodiments of the present application may be provided as a method, a system, or a computer program product. Therefore, the present application may use a form of hardware only embodiments, software only embodiments, or embodiments with a combination of software and hardware. Moreover, the present application may use a form of a computer program product that is implemented on one or more computer-usable storage media (comprising but not limited to a disk memory, a CD-ROM, an optical memory, and the like) that comprise computer usable program code.

The present application is described with reference to the flowcharts and/or block diagrams of the method, the device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that comprises an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computer device comprises one or more central processing units (CPUs), an input/output interface, a network interface, and a memory. The memory may comprise forms of a volatile memory, a random access memory (RAM), and/or a non-volatile memory and the like, such as a read-only memory (ROM) or a flash RAM in a computer-readable medium. The memory is an example of the computer-readable medium.

The computer-readable medium comprises non-volatile and volatile media, and removable and non-removable media, wherein information storage can be implemented with any method or technology. Information may be modules of computer-readable instructions, data structures and programs, or other data. Examples of a computer storage medium comprise but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, or any other non-transmission media that may be used to store information capable of being accessed by a computing device. According to the definitions herein, the computer-readable medium does not comprise transitory media, such as modulated data signals and carrier waves.

It should further be noted that the terms “include”, “comprise”, or any variation thereof are intended to cover a non-exclusive inclusion. Therefore, in the context of a process, method, commodity, or device that comprises a series of elements, the process, method, commodity, or device not only comprises such elements, but also comprises other elements not specified expressly, or may comprise inherent elements of the process, method, commodity, or device. If no more limitations are made, an element limited by “comprise a/an . . . ” does not exclude other same elements existing in the process, the method, the article, or the device which comprises the element.

The foregoing descriptions are merely embodiments of the present application and are not used to limit the present application. A person skilled in the art may make various changes and variations to the present application. Any modifications, equivalent replacements, and improvements made without departing from the spirit and principle of the present application shall fall within the scope of the claims of the present application.

1. A method for estimating a stock price, comprising:
obtaining current tick data of a stock, wherein the current tick data comprises N best prices and buy and sell volumes of the stock corresponding to the N best prices, wherein, N is a positive integer greater than 1;
determining, by using an amount of money to be invested or an amount of money to be withdrawn and the current tick data, a final transaction price if all the amount of money to be invested is used to buy the stock or all the amount of money to be withdrawn is obtained by selling the stock; and
presenting the final transaction price in real time for an investor's reference.

2. The method according to claim 1, wherein
the current tick data comprises: an N^{th} best seller price sequentially arranged in an ascending order of price and an N^{th} best seller stock volume; and
the step of determining, by using the amount of money to be invested or the amount of money to be withdrawn and the current tick data, the final transaction price if all the amount of money to be invested is used to buy the stock or all the amount of money to be withdrawn is obtained by selling the stock, comprises:
receiving the amount of money to be invested;
sequentially buying the stock at the N^{th} best seller price in ascending order of seller price by using the amount of money to be invested; and
if the amount of money to be invested is used up, taking a price at which the stock is bought when the amount of money to be invested is used up as the final transaction price.

3. The method according to claim 2, further comprising:
if the amount of money to be invested is not used up, calculating the first proportional relationship between a money usage of the amount of money to be invested and the amount of money to be invested; and
determining the final transaction price by making a second proportional relationship between a first difference and a second difference equal the first proportional relationship, wherein the second difference is a difference between the final transaction price and a current market price, and the first difference is a difference between the N^{th} best seller price and the current market price.

4. The method according to claim 1, wherein
the current tick data comprises: an N^{th} best buyer price sequentially arranged in descending order of price and an N^{th} best buyer stock volume; and
the step of determining, by using the amount of money to be invested or the amount of money to be withdrawn and the current tick data, a final transaction price if all the amount of money to be invested is used to buy the stock or all the amount of money to be withdrawn is obtained by selling the stock comprises:
receiving the amount of the money to be withdrawn;
sequentially trading the stock at the N^{th} best buyer price in descending order of buyer price; and
if the amount of the money to be withdrawn is reached through accumulation, taking a price at which the stock is traded when the amount of money to be invested is reached as the final transaction price.

5. The method according to claim 4, wherein
if the amount of the money to be withdrawn is not reached, a third proportional relationship between an accumulated amount of money having been withdrawn currently and the amount of money to be withdrawn is calculated; and
the final transaction price is determined by making a fourth proportional relationship between a third difference and a fourth difference equal the third proportional relationship, wherein the third difference is a difference between the current market price and the N^{th} best buyer price, and the fourth difference is a difference between the current market price and the final transaction price.

6. The method according to claim 1, wherein
the step of determining, by using the amount of money to be invested or the amount of money to be withdrawn and the current tick data, a final transaction price if all the amount of money to be invested is used to buy the stock or all the amount of money to be withdrawn is obtained by selling the stock, comprises:
calculating, by using the current tick data, a full amount of money for trading all stocks in a current tick;
calculating a fifth proportional relationship between the amount of money to be invested or the amount of money to be withdrawn and the full amount of money; calculating a sixth comparison relationship between a fifth difference and a sixth difference, wherein the fifth difference is a difference between the final transaction price and the current market price, and the sixth difference is a seller price maximum difference or a buyer price maximum difference in the current tick data; and
determining the final transaction price by making the fifth proportional relationship equal the sixth proportional relationship.

7. A stock price estimation apparatus, comprising:
a module for obtaining current tick data, configured to obtain current tick data of a stock, wherein the current tick data comprises N best prices and corresponding buy and sell volumes of the stock, wherein N is a positive integer greater than 1;
a module for determining a final transaction price, configured to determine, by using an amount of money to be invested or an amount of money to be withdrawn and the current tick data, a final transaction price if all the amount of money to be invested is used to buy the stock or all the amount of money to be withdrawn is obtained by selling the stock; and
a real-time price presentation module, configured to present the final transaction price in real time for an investor's reference.

8. The stock price estimation apparatus according to claim 7, wherein
the module for determining a final transaction price comprises:
a unit for calculating a full amount of money, configured to calculate, by using the current tick data, a full amount of money for trading all stocks in a current tick;
a difference proportion determination unit, configured to: calculate a fifth proportional relationship between the amount of money to be invested or the amount of money to be withdrawn and the full amount of money; and calculate a sixth comparison relationship between a fifth difference and a sixth difference, wherein the fifth difference is a difference between the final transaction price and the current market price, and the sixth difference is a seller price maximum difference or a buyer price maximum difference in the current tick data; and
a final price determination unit, configured to determine the final transaction price by making the fifth proportional relationship equal the sixth proportional relationship.

9. A stock price estimation device, comprising:
a memory, configured to store a computer program; and
a processor, configured to implement, when executing the computer program, the steps of the method according to claim 1.

10. A computer-readable storage medium, wherein the computer-readable storage medium stores a computer program, and the computer program implements, when being executed by the processor, the steps of the method according to claim 1.

11. The stock price estimation device of claim 9, wherein
the current tick data comprises: an N^{th} best seller price sequentially arranged in an ascending order of price and an N^{th} best seller stock volume; and
the step of determining, by using the amount of money to be invested or the amount of money to be withdrawn and the current tick data, the final transaction price if all the amount of money to be invested is used to buy the stock or all the amount of money to be withdrawn is obtained by selling the stock, comprises:
receiving the amount of money to be invested;
sequentially buying the stock at the N^{th} best seller price in ascending order of seller price by using the amount of money to be invested; and
if the amount of money to be invested is used up, taking a price at which the stock is bought when the amount of money to be invested is used up as the final transaction price.

12. The stock price estimation device of claim 11, wherein the method further comprises:
if the amount of money to be invested is not used up, calculating the first proportional relationship between a money usage of the amount of money to be invested and the amount of money to be invested; and
determining the final transaction price by making a second proportional relationship between a first difference and a second difference equal the first proportional relationship, wherein the second difference is a difference between the final transaction price and a current market price, and the first difference is a difference between the N^{th} best seller price and the current market price.

13. The stock price estimation device of claim 9, wherein
the current tick data comprises: an N^{th} best buyer price sequentially arranged in descending order of price and an N^{th} best buyer stock volume; and
the step of determining, by using the amount of money to be invested or the amount of money to be withdrawn and the current tick data, a final transaction price if all the amount of money to be invested is used to buy the stock or all the amount of money to be withdrawn is obtained by selling the stock comprises:
receiving the amount of the money to be withdrawn;
sequentially trading the stock at the N^{th} best buyer price in descending order of buyer price; and
if the amount of the money to be withdrawn is reached through accumulation, taking a price at which the stock is traded when the amount of money to be invested is reached as the final transaction price.

14. The stock price estimation device of claim 13, wherein
if the amount of the money to be withdrawn is not reached, a third proportional relationship between an accumulated amount of money having been withdrawn currently and the amount of money to be withdrawn is calculated; and
the final transaction price is determined by making a fourth proportional relationship between a third difference and a fourth difference equal the third proportional relationship, wherein the third difference is a difference between the current market price and the N^{th} best buyer price, and the fourth difference is a difference between the current market price and the final transaction price.

15. The stock price estimation device of claim 9, wherein
the step of determining, by using the amount of money to be invested or the amount of money to be withdrawn and the current tick data, a final transaction price if all the amount of money to be invested is used to buy the stock or all the amount of money to be withdrawn is obtained by selling the stock, comprises:
calculating, by using the current tick data, a full amount of money for trading all stocks in a current tick;
calculating a fifth proportional relationship between the amount of money to be invested or the amount of money to be withdrawn and the full amount of money; calculating a sixth comparison relationship between a fifth difference and a sixth difference, wherein the fifth difference is a difference between the final transaction price and the current market price, and the sixth difference is a seller price maximum difference or a buyer price maximum difference in the current tick data; and
determining the final transaction price by making the fifth proportional relationship equal the sixth proportional relationship.

16. The computer-readable storage medium of claim 10, wherein
the current tick data comprises: an N^{th} best seller price sequentially arranged in an ascending order of price and an N^{th} best seller stock volume; and
the step of determining, by using the amount of money to be invested or the amount of money to be withdrawn and the current tick data, the final transaction price if all the amount of money to be invested is used to buy the stock or all the amount of money to be withdrawn is obtained by selling the stock, comprises:
receiving the amount of money to be invested;
sequentially buying the stock at the N^{th} best seller price in ascending order of seller price by using the amount of money to be invested; and
if the amount of money to be invested is used up, taking a price at which the stock is bought when the amount of money to be invested is used up as the final transaction price.

17. The computer-readable storage medium of claim 16, wherein the method further comprises:
if the amount of money to be invested is not used up, calculating the first proportional relationship between a money usage of the amount of money to be invested and the amount of money to be invested; and
determining the final transaction price by making a second proportional relationship between a first difference and a second difference equal the first proportional relationship, wherein the second difference is a difference between the final transaction price and a current market price, and the first difference is a difference between the N^{th} best seller price and the current market price.

18. The computer-readable storage medium of claim 10, wherein
the current tick data comprises: an N^{th} best buyer price sequentially arranged in descending order of price and an N^{th} best buyer stock volume; and
the step of determining, by using the amount of money to be invested or the amount of money to be withdrawn and the current tick data, a final transaction price if all the amount of money to be invested is used to buy the stock or all the amount of money to be withdrawn is obtained by selling the stock comprises:
receiving the amount of the money to be withdrawn;
sequentially trading the stock at the N^{th} best buyer price in descending order of buyer price; and
if the amount of the money to be withdrawn is reached through accumulation, taking a price at which the stock is traded when the amount of money to be invested is reached as the final transaction price.

19. The computer-readable storage medium of claim 18, wherein
if the amount of the money to be withdrawn is not reached, a third proportional relationship between an accumulated amount of money having been withdrawn currently and the amount of money to be withdrawn is calculated; and
the final transaction price is determined by making a fourth proportional relationship between a third difference and a fourth difference equal the third proportional relationship, wherein the third difference is a difference between the current market price and the N^{th} best buyer price, and the fourth difference is a difference between the current market price and the final transaction price.

20. The computer-readable storage medium of claim 10, wherein
the step of determining, by using the amount of money to be invested or the amount of money to be withdrawn and the current tick data, a final transaction price if all the amount of money to be invested is used to buy the stock or all the amount of money to be withdrawn is obtained by selling the stock, comprises:
calculating, by using the current tick data, a full amount of money for trading all stocks in a current tick;
calculating a fifth proportional relationship between the amount of money to be invested or the amount of money to be withdrawn and the full amount of money; calculating a sixth comparison relationship between a fifth difference and a sixth difference, wherein the fifth difference is a difference between the final transaction price and the current market price, and the sixth difference is a seller price maximum difference or a buyer price maximum difference in the current tick data; and
determining the final transaction price by making the fifth proportional relationship equal the sixth proportional relationship.
